(19) United States
(12) Patent Application Publication
(10) Pub. No.: US 2008/0037921 A1
(43) Pub. Date: Feb. 14, 2008

(54) Self-Aligning Roller Bearing

(75) Inventor: Tadahiro Hoshino, Yokohama-shi/Kanagawa (JP)

Correspondence Address: CROWELL & MORING LLP;INTELLECTUAL PROPERTY GROUP, P.O. BOX 14300, WASHINGTON, DC, 20044-4300, US

(73) Assignee: NSK Ltd., Tokyo (JP)

(21) Appl. No.: 10/584,936

(22) PCT Filed: Apr. 25, 2005
(86) PCT No.: PCT/JP05/07791

§ 371 Date: Jul. 5, 2006

(30) Foreign Application Priority Data
May 31, 2004 (JP) 2004-161602

(51) Int. Cl. F16C 23/08

(52) U.S. Cl. 384/558

(57) ABSTRACT

It is intended to easily insert rollers into a cage at an approximately optimum insertion angle and in a stabilized attitude, thereby preventing poor insertion of rollers and roller disengagement. A self-aligning roller bearing having a cage (10) which comprises an annular section (12) having a pocket (11) for containing a roller (3), an outward flange (13) extending radially outward on the head side of the rollers (3) in the annular section (12) and holding the heads of the rollers (3), a pawl (14) projecting from the outward flange (13) to engage the head of the roller (3), and a small-diameter flange (15) disposed on the tail side of the rollers (3) in the annular section (12), wherein the outer periphery side of the small-diameter flange (15) of the cage (10) is provided with a roller inserting guide (20) in which a guide surface (21) approximately parallel with the direction of contact angle of the rollers (3) is disposed along the inner surface (11a) of the pocket (11) on the small-diameter flange (15) side.

### TECHNICAL FIELD

The present invention concerns improvement in a cage of a self-aligning roller bearing used, for example, in general industrial machines.

### BACKGROUND ART

In self-aligning roller bearings, since the state of contact of rolling elements does not change even in a case where outer rings or inner rings are tilted by error upon attachment or impact load, they have advantages capable of preventing occurrence of abnormal loads and providing large radial load. Accordingly, self-aligning roller bearings have been generally utilized also as various kinds of roll neck bearings for paper making machines, vehicle bearings and bearings for use in various industries.

FIG. 6 and FIG. 7 show an example of an existent self-aligning roller bearing and, in the self-aligning roller bearing, double row spherical rollers 3 as rolling elements are arranged between an inner ring 1 having a double row raceway 1a and an outer ring 2 having an integral spherical double row raceway 2a by way of cages 4 respectively such that they can roll in the circumferential direction.

The cage 4 is formed integrally by means of press molding, etc. and includes an annular section 6 having a pocket 5 for containing a spherical roller 3, an outward flange 7a radially extended outward from the annular section 6 on the head side of the spherical roller 3 for retaining the head of the spherical roller 3, a pawl 8 protruded from the outward flange 7a for engagement with the head of the spherical roller 3, and a small-diameter flange 7b (refer to FIG. 8) disposed to the annular section 6 on the tail side of the spherical roller 3.

By the way, the pawl 8 protruded from the outward flange 7a is for engagement with the concave 3a formed in the head of the spherical roller 3 after insertion of the spherical roller 3 into the cage 4 thereby preventing the spherical roller 3 from detaching out of the cage 4. However, upon insertion of the spherical roller 3 in the cage 4, it is necessary to override the pawl 8 as shown in FIG. 9, and, accordingly, the operation of inserting the spherical roller 3 is conducted by using an insertion facility, jig or the like used exclusively therefor such as a cylinder device 9.

In this case, as shown in FIG. 9, in a case where the spherical roller 3 can be inserted in the direction of a directional line C orthogonal to a shortest distance directional line B between the inner lateral surface 5a of the pocket 5 on the side of the small-diameter flange 7b and the pawl 8 as shown in FIG. 9, the insertion operation for the spherical roller 3 is facilitated. However, in the existent cage, since a point Al where the inner lateral surface 5a of the pocket 5 on the side of the small-diameter flange 7b crosses the shortest distance directional line B and a point A2 where the pawl 8 crosses the shortest distance directional line B are arranged substantially at an identical position relative to the inserting direction of the spherical roller 3, when the spherical roller 3 is inserted at an optimal angle (angle orthogonal to the shortest distance directional line B), the top end of the spherical roller 3 in the insertion direction is caught by the pawl 8 and the inner lateral surface 5a to make the attitude of the roller instable and the spherical roller can no more be inserted easily into the cage 4.

Then, in the prior art, as shown in FIG. 10, the spherical roller 3 is inserted at first from the side of the small-diameter flange 7b (tail side of the roller) at an angle of an optimal angle+α, and then the spherical roller 3 is inserted into the cage 4 while deforming the pawl 8 under rotation of the spherical roller 3 by the cylinder device 9 with the point A1 on the inner lateral surface 5a on the side of the small-diameter flange 7b being as a start point. The directional line D in FIG. 9 and FIG. 10 shows an extending/contracting direction of the cylinder device 9.

### DISCLOSURE OF THE INVENTION

However, in the existent cage 4 for use in self-aligning roller bearings, in a case of inserting the spherical roller 3 at the angle of the optimal angle+α on the side of the small-diameter flange 7b (tail side of the roller) into the cage 4, an excessively large force is required for overriding the pawl 8 to result in a problem of tending to cause poor insertion even by the use of an insertion device, jig, etc. used exclusively therefor.

Further, when the spherical roller 3 is inserted into the cage 4 and caused to override the pawl 8, the pawl 8 is sometimes deformed plastically and, in such a case, the pawl 8 no more engages the concave 3a in the head of the spherical roller 3 to possibly detach the spherical roller 3 from the cage 4.

The present invention has been achieved in order to overcome such drawbacks and it is an object thereof to provide a self-aligning roller bearing capable of easily inserting a roller into a cage in a stable attitude at a substantially optimal insertion angle thereby capable of preventing poor insertion and detachment of the rollers.

For attaining the foregoing object, the invention according to claim 1 concerns a self-aligning roller bearing in which double row rollers are arranged as rolling elements between an inner ring and an outer ring each by way of a cage such that they can roll in the circumferential direction, and the cage includes an annular section having a pocket for containing the roller, an outward flange disposed to and radially extended outward from the annular section on the head side of the roller for retaining the head of the roller, a pawl protruded on the outward flange and engaging the head of the roller, and a small-diameter flange disposed to the annular section on the tail side of the roller, characterized in that an insertion guide is disposed on the side of the outer circumference of the small-diameter flange of the cage, with a guide surface substantially in parallel with the direction of an angle of contact of the roller being provided to the pocket on the side of the small-diameter flange.

### BRIEF DESCRIPTION OF THE DRAWINGS

FIG. 1 is a cross sectional view of a main portion for explaining a self-aligning roller bearing as an example of an embodiment according to the present invention.

FIG. 2 is a view of the self-aligning roller bearing of FIG. 1 viewed in the axial direction.

FIG. 3 is a perspective view of a small-diameter flange provided with a roller inserting guide.

FIG. 4 is a cross sectional view for explaining the method of inserting the roller.

FIG. 5 is a cross sectional view for explaining a cage of a self-aligning roller bearing of another embodiment the present invention.

FIG. 6 is a cross sectional view of a main portion for explaining an existent self-aligning roller bearing.

FIG. 7 is a view of the self-aligning roller bearing of FIG. 6 viewed in the axial direction.

FIG. 8 is a perspective view of a small-diameter flange.

FIG. 9 is a cross sectional view for explaining the existent method of inserting a roller.

FIG. 10 is a cross sectional view for explaining the existent method of inserting a roller.

### DESCRIPTION OF REFERENCES

1 inner ring

2 outer ring

3 spherical roller

10 cage for self-aligning roller bearing

11 pocket

11a inner lateral surface of a pocket on the side of a small-diameter flange

12 annular section

13 outward flange

14 pawl

15 small-diameter flange

20 roller inserting guide

21 guise surface

### BEST MODE FOR PRACTICING THE INVENTION

An example of an embodiment of the present invention is to be described with reference to the drawings.

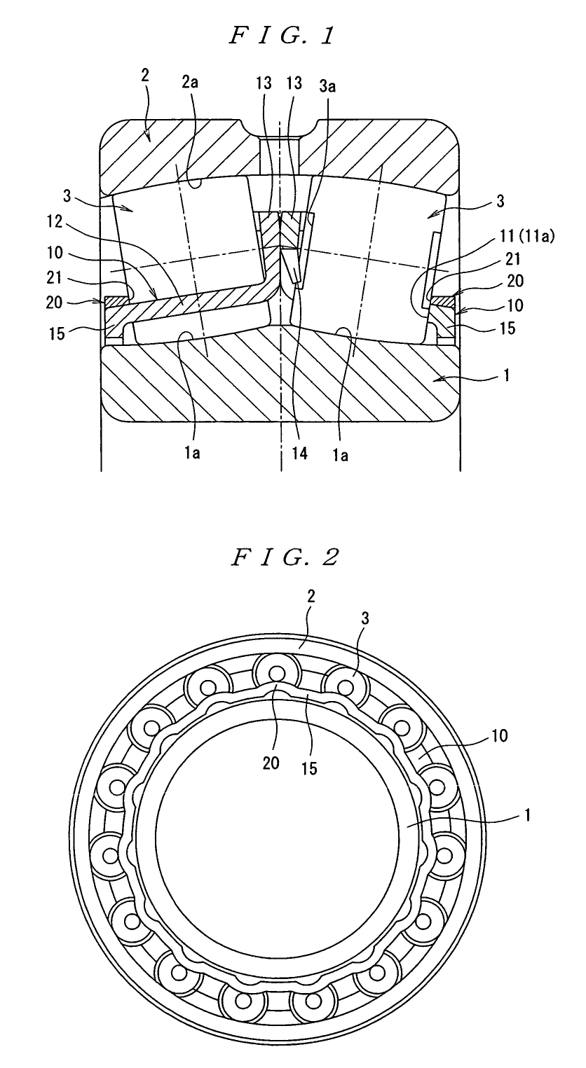

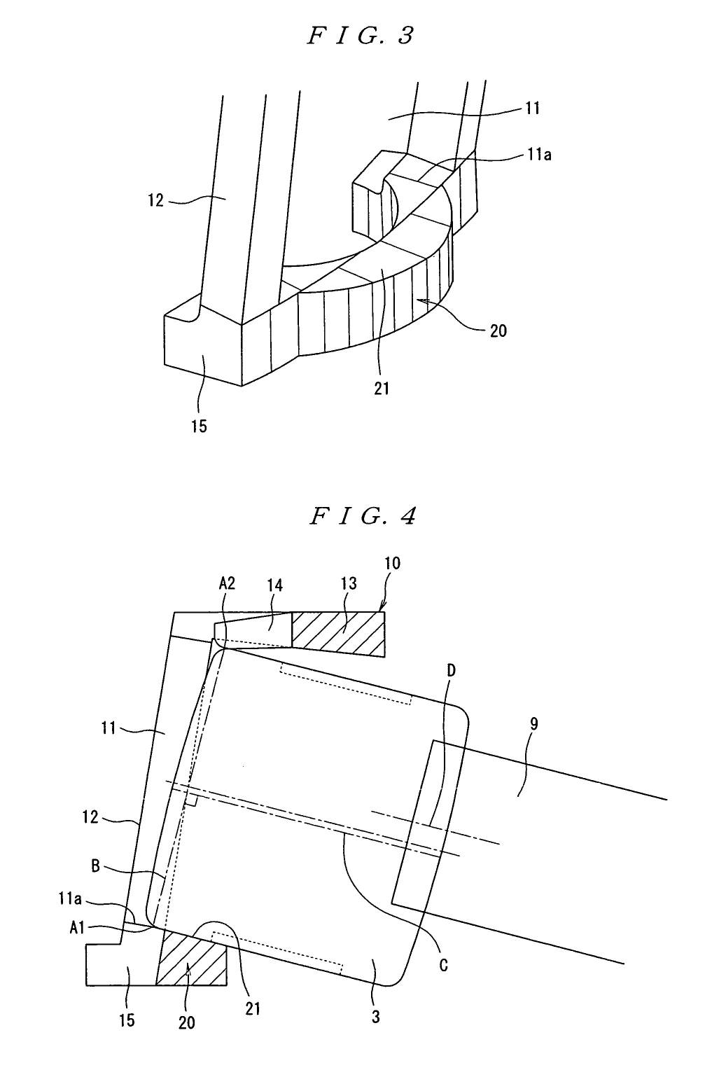

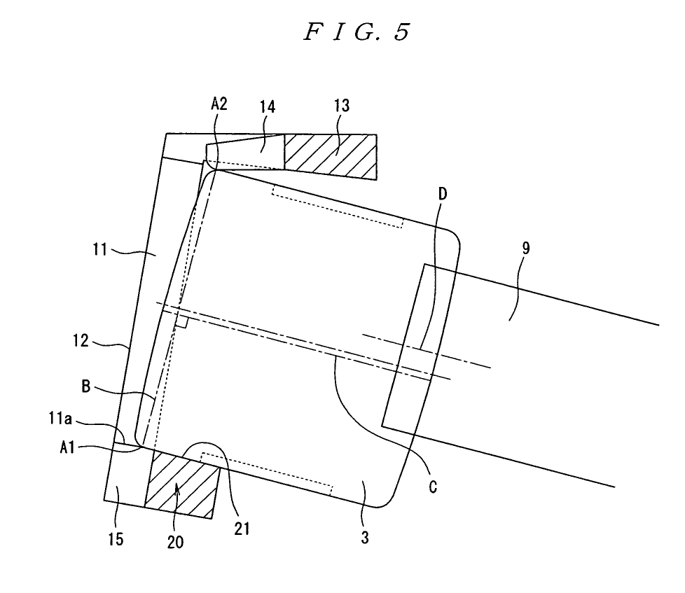

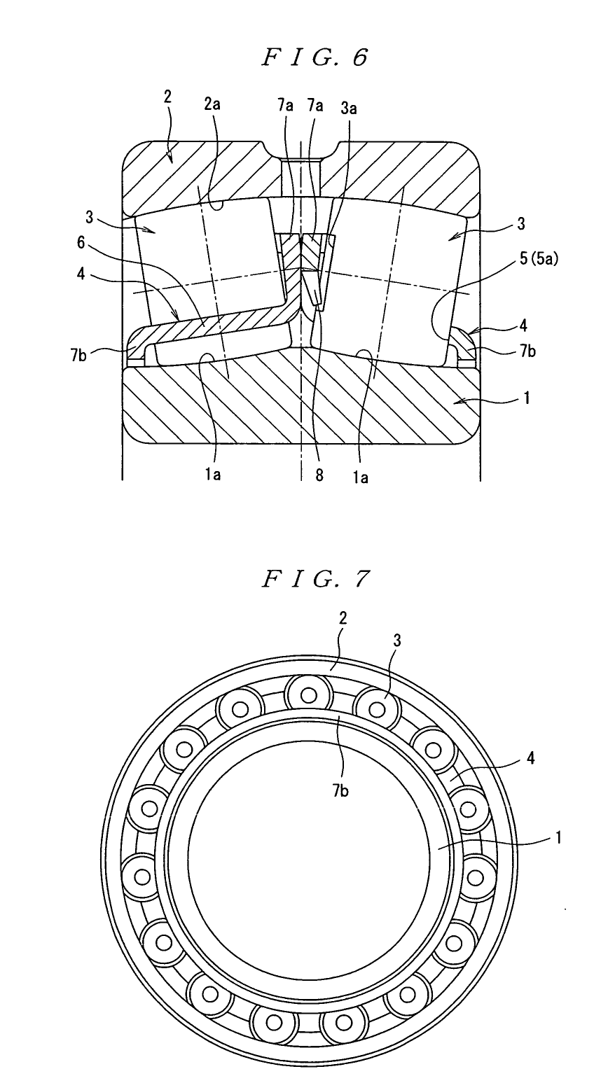

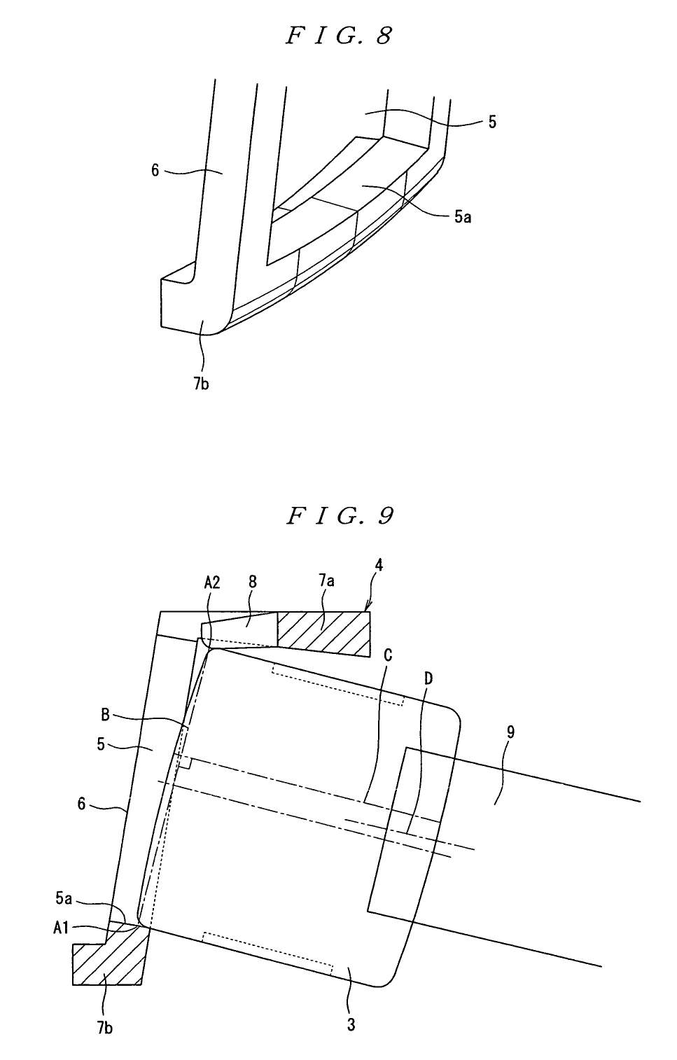

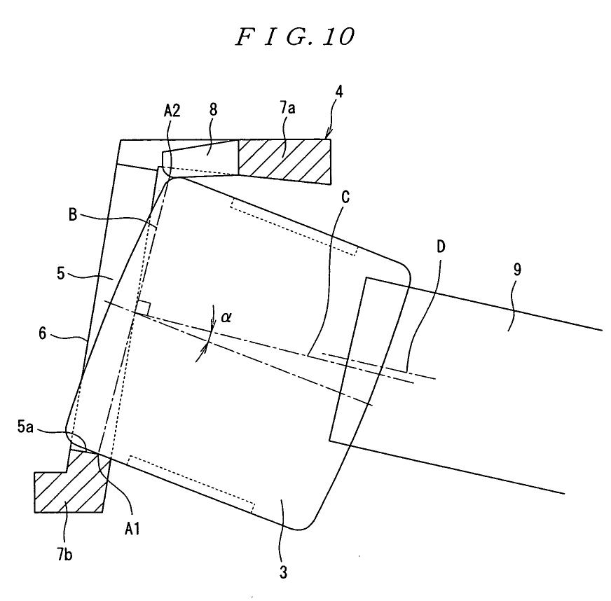

FIG. 1 is a cross sectional view of a main portion for explaining a self-aligning roller bearing as an example of an embodiment according to the present invention. FIG. 2 is a view of the self-aligning roller bearing of FIG. 1 viewed in the axial direction, FIG. 3 is a perspective view of a small-diameter flange provided with a roller inserting guide, FIG. 4 is a cross sectional view for explaining the method of inserting the roller, and FIG. 5 is a cross sectional view for explaining a cage of a self-aligning roller bearing of another embodiment according to the present invention. Since each of the embodiments is different from the self-aligning roller bearing already explained for FIG. 6 and FIG. 7 only with respect to the cage, duplicate portions carry identical reference numerals in each of the drawings while omitting the description therefor, and only the cage is to be described.

A cage 10 assembled in the self-aligning roller bearing as an example of the embodiment of the present invention is formed integrally, for example, by press molding and, as shown in FIG. 1 to FIG. 3, includes an annular section 12 having a pocket 11 for containing a spherical roller 3, an outward flange 13 disposed to and radially extended outward from the annular section 12 on the head side of the spherical roller 3 for retaining the head of the spherical roller 3, a pawl 14 protruded on the outward flange 13 for engagement with the head of the spherical roller 3, and a small-diameter flange 15 disposed to the annular section 12 on the tail side of the spherical roller 3.

Then, the pawl 14 protruded on the outward flange 13 engages the concave 3a formed in the head of the spherical roller 3 after insertion of the spherical roller 3 into the cage 10 thereby preventing the spherical roller 3 from detaching out of the cage 10.

Then, in this embodiment, a roller inserting guide 20 is disposed on the outer circumferential side of the small-diameter flange 15 of the cage 10, and a guide surface 21 substantially in parallel with the direction of an angle of contact of the spherical roller 3 is disposed to the roller inserting guide 20 along the inner lateral surface 11a of the pocket 11 on the side of the small-diameter flange 15. Further, the roller inserting guide 20 is formed by applying caulking to the small-diameter flange 15 thereby radially bending the same in an arcuate shape outward of the cage 10 as shown in FIG. 2 and FIG. 3.

As described above, in this embodiment, since the guide surface 21 substantially in parallel with the direction of the angle a contact of the spherical roller 3 is formed, along the inner lateral surface 11a of the pocket 11 on the side of the small-diameter flange 15 to the roller inserting guide 20 disposed on the outer circumferential side of the small-diameter flange 15 of the cage 10, the attitude of the spherical roller 3 can be controlled to a stable state by the guide surface 21 of the roller inserting guide 20 before contact of the top end of the spherical roller 3 in the insertion direction with a point A1 where the inner lateral surface 11a of the pocket 11 on the side of the small-diameter flange 15 crosses the shortest distance directional line B and with a point A2 where the pawl 14 crosses the shortest distance directional line B with reference to FIG. 4.

As a result, also in a case of inserting the spherical roller 3 into the cage 10 at a substantially optimal insertion angle (angle orthogonal to the shortest distance directional line B), the spherical roller 3 can be inserted easily into the cage 10 with a considerably smaller force than usual under deformation of the pawl 14 while rotating the roller in a stable attitude by a cylinder device 9, thereby capable of preventing poor insertion of the roller or detachment of the roller.

Further, since the roller inserting guide 20 is formed by applying caulking to the small-diameter flange 15, the roller inserting guide 20 can be formed easily without increasing the number of parts but by merely changing the shape of the existent cage.

The constitution of the self-aligning roller bearing, the inner ring, the outer ring, the roller, the cage, the pocket, the annular section, the outward flange, the pawl, the small-diameter flange, the guide surface, the inner lateral surface of the pocket on the side of the small-diameter flange, the roller inserting guide, etc. in the present invention are not restricted to those of the embodiment described above but they can be properly modified within a range not departing the gist of the invention.

For example, while the embodiment described above shows an example of forming the roller inserting guide 20 by applying caulking to the small-diameter flange 15, the roller inserting guide 20 may alternatively be formed integrally with the cage by burring fabrication as shown in FIG. 5.

Further, it may also be formed by applying crushing to the small-diameter flange portion 7b.

### INDUSTRIAL APPLICABILITY

According to the present invention, since the roller inserting guide is disposed on the outer circumferential side of the small-diameter flange of the cage with the guide surface substantially in parallel with the direction of the angle of contact of the roller being disposed to the pocket on the side of the small-diameter flange, the spherical roller can be inserted easily into the cage in a stable attitude substantially at an optimal insertion angle, thereby capable of preventing poor insertion of the roller or detachment of the roller.

In this case, the roller inserting guide can easily be formed without increasing the number of parts but by merely changing the shape of the existent cage, by applying caulking to the small-diameter flange thereby forming the roller inserting guide.

1. A self-aligning roller bearing in which double row rollers are arranged as rolling elements between an inner ring and an outer ring each by way of a cage such that they can roll in the circumferential direction, and the cage includes an annular section having a pocket for containing the roller, an outward flange disposed to and radially extended outward from the annular section on the head side of the roller for retaining the head of the roller, a pawl protruded on the outward flange and engaging the head of the roller, and a small-diameter flange disposed to the annular section on the tail side of the roller, characterized in that
a roller inserting guide is disposed on the side of the outer circumference of the small-diameter flange of the cage, with a guide surface substantially in parallel with the direction of an angle of contact of the roller being provided to the pocket on the side of the small-diameter flange.
